(19) United States
(12) Patent Application Publication
(10) Pub. No.: US 2015/0216158 A1
(43) Pub. Date: Aug. 6, 2015

(54) SYSTEM FOR AUTOMATIC TRAPPING AND COUNTING OF FLYING INSECTS

(71) Applicant: The State of Israel, Ministry of Agriculture & Rural Dev., Agri. Research Org. (ARO) (Volcanic Ce, Beit-Dagan (IL)

(72) Inventors: Amos Mizrach, Rishon-LeZion (IL); Yafit Cohen, Kiriat Ono (IL); Clara Shenderey, Nesher (IL); Lavi Rosenfeld, Lod (IL); Yoav Gazit, Yehud-Monosson (IL); Doron Timar, Kidron (IL); Yosef Grinshpon, Holon (IL)

(21) Appl. No.: 14/425,680

(22) PCT Filed: Aug. 26, 2013
(86) PCT No.: PCT/IL2013/050720

§ 371 Date: Mar. 4, 2015

Related U.S. Application Data
(60) Provisional application No. 61/743,325, filed on Sep. 4, 2012.

(51) Int. Cl. A01M 1/02; A01M 1/20; A01M 1/10

(52) U.S. Cl. CPC A01M 1/026; A01M 1/02; A01M 1/106; A01M 1/2016

(57) ABSTRACT

A system for automatic trapping and counting of flying insects is disclosed forthwith. The system lures flying insects into a main chamber where they are killed or stunned by a toxin. The killed and the stunned insects fall pass an optical sensor which counts the number of killed stunned insects.

The number of killed and stunned insects is transmitted to a central monitoring station which can receive count data from multiple systems for automatic trapping and counting of flying insects spread around a monitored area.

By analyzing the insect count from a number of systems for automatic trapping and counting of flying insects, the central monitoring station can initiate the spread of insecticides in real-time.

### REFERENCE TO CROSS-RELATED APPLICATION

This application claims priority from U.S. Provisional Application No. 61/743,325, filed on Sep. 4, 2012, herein incorporated by reference in its entirety.

### FIELD OF THE INVENTION

The present invention relates to systems for trapping insects, more particularly, to systems for automatic trapping and counting of flying insects.

### BACKGROUND OF THE INVENTION

Flying insects such as the Mediterranean Fruit Fly (Ceratitis capitata), Eastern Fruit Fly (Bactrocera dorsali) and others are pests, harmful to a variety of crops such as citrus trees, deciduous trees and various sub-tropical species.

Due to the harmful nature of such pests it is important to monitor the population of such pests in and around groves and plantations of sensitive crops.

Most farmers and agriculture professionals use the highly common Steiner traps to capture the insects, and kill them and, subsequently, the number of trapped insects can be counted by manual labor. Normally, the traps are placed in and around the groves for a number of days after which they are collected and the trapped insects are counted.

Once an increase in insect population is detected by the count of trapped insects, pesticide is applied to contaminated areas.

The method above is lacking in the sense that there is no indication as to when the insects were trapped during the period of time that the trap was set as well as no indication to other factors such as the temperature, humidity and time of day of the insects' capture.

The lack of real time monitoring may cause delays in applying the pesticide, thus resulting in loss and damage to the crops.

None of the prior art devices overcomes all of the above deficiencies.

There is therefore a need for a system for automatic trapping and counting of flying insects, which overcomes all of the above deficiencies.

### SUMMARY OF THE INVENTION

The background art does not teach or suggest a system for automatic trapping and counting of flying insects.

The present invention overcomes these deficiencies of the background art by providing a system for automatic trapping and counting of flying insects.

According to the present invention there is provided a system for automatic trapping and counting of flying insects (1), the system including: (a) a main chamber (12) having at least one intake (10); (b) a toxin chamber (20) having a toxin chamber neck (22), the toxin chamber (20) being located at least partly inside the main chamber (12); (c) a funnel (30) located inside the main chamber (12); (d) a channel (31) attached to the funnel (30); (e) a sensors assembly (40) attached to the channel (31); and (g) an insect collecting chamber (50), located inside the main chamber (12).

According to another feature of the present invention the toxin chamber (20) is configured to contain toxin (21).

According to another feature of the present invention the toxin (21) contains a mixture of compounds for attracting and killing insects.

According to another feature of the present invention the toxin (21) contains a mixture of para-pheromone and Dichlorvos.

According to another feature of the present invention the toxin chamber neck (22) is covered by a mesh (23), wherein the mesh (23) is configured for keeping certain insects from entering the toxin chamber (21).

According to another feature of the present invention the toxin chamber (20) is configured to be located, at operation, higher than the sensors assembly (40).

According to another feature of the present invention the toxin chamber (20) is configured to be located, at operation, higher than the insect collecting chamber (50).

According to another feature of the present invention the system for automatic trapping and counting of flying insects (1) further including: (h) an electronic sub-system chamber (60) mechanically connected to the main chamber (12).

According to another feature of the present invention the electronic sub-system chamber (60) contains at least part of an electronic sub-system (61).

According to another feature of the present invention the sensors assembly (40) includes at least one optical sensor (41).

According to another feature of the present invention the electronic sub-system (61) includes: (i) an operational amplifier (43) operatively connected to the at least one optical sensor (41); and (ii) a counter (44) operatively connected to the operational amplifier (43).

According to another feature of the present invention the electronic sub-system (61) is configured to transmit counted data to a receiver (72) wherein the count data serves as input to a central monitoring station (74).

According to another feature of the present invention the central monitoring station (74) is configured also for collecting data from other systems for automatic trapping and counting of flying insects (1).

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 is a perspective schematic illustration of an exemplary, illustrative embodiment of a system for automatic trapping and counting of flying insects according to the present invention.

FIG. 2 is a top view schematic illustration of the system for automatic trapping and counting of flying insects of the above embodiment upon which the section plane a-a is marked.

FIG. 3 is a perspective schematic cross sectional view a-a of the system for automatic trapping and counting of flying insects.

FIG. 4 is an electrical schematic of an exemplary embodiment of an electronic sub-system of the system for automatic trapping and counting of flying insects, according to the present invention.

FIG. 5 is a block diagram of an embodiment of the electrical portion of the system for automatic trapping and counting of flying insects, according to the present invention.

In order to leave no room for doubt, the elements shown in the illustrations of the present patent application in a manner that enables understanding them clearly, and the scales, size relations, and shapes are not in any way limiting their embodiment.

### DETAILED DESCRIPTION OF EMBODIMENTS

To remove any doubt, note that the manner in which the elements of the present invention are described in the illustrations can be highly detailed, however is not in any way limiting the present illustration, however is for the purpose of clarification and furthering understanding. The present invention can be implemented in embodiments that differ from the specification given with regard to the illustration.

The present invention is of a system for automatic trapping and counting of flying insects.

The principles and operation of a system for automatic trapping and counting of flying insects according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:

1 system for automatic trapping and counting of flying insects

10 intake

12 main chamber

20 toxin chamber

21 toxin

22 toxin chamber neck

23 mesh

30 funnel

31 channel

40 sensors assembly

41 optical sensor

42 light sensitive transistor

43 operational amplifier

44 counter

45 voltage regulator

46 light emitting diode (LED)

47 resistance adjustable resistor

48 capacitor

49 resistor

50 insect collecting chamber

60 electronic sub-system chamber

61 electronic sub-system

70 transmitter

72 receiver

74 central monitoring station

80 electrical portion

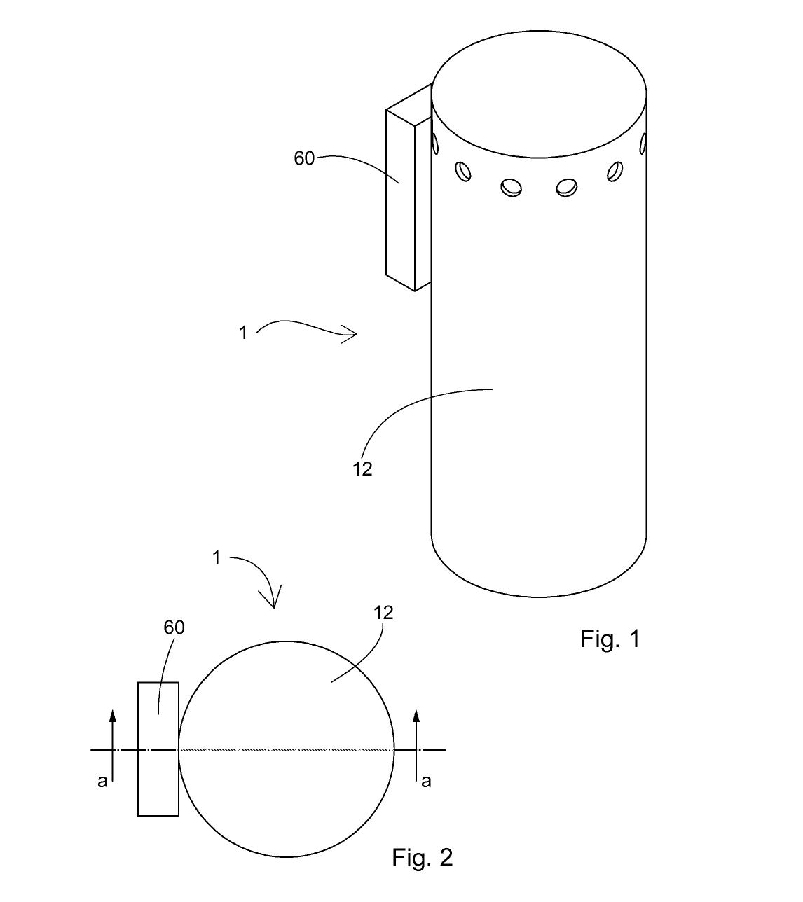

Referring now to the drawings, FIG. 1 is a perspective schematic illustration of an exemplary, illustrative embodiment of a system for automatic trapping and counting of flying insects 1 according to the present invention.

The system for automatic trapping and counting of flying insects 1 two main components are a main chamber 12 and an electronic sub-system chamber 60.

FIG. 2 is a top view schematic illustration of the system for automatic trapping and counting of flying insects 1 of the above embodiment upon which the section plane a-a is marked.

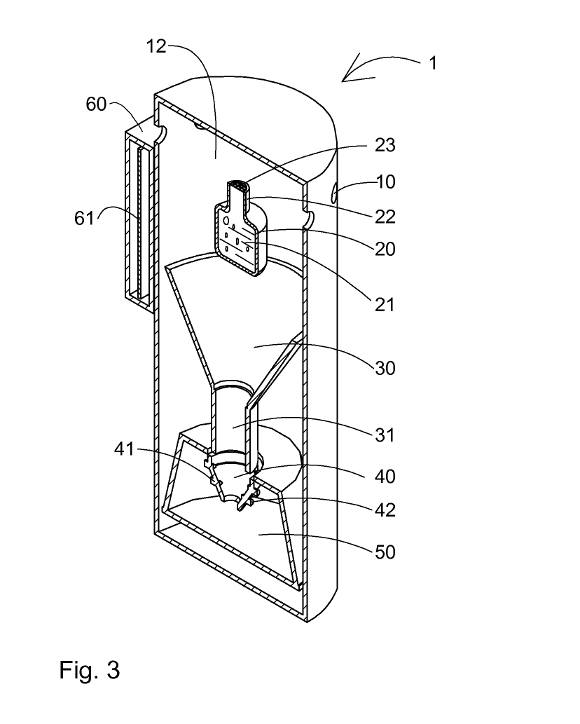

FIG. 3 is a perspective schematic cross sectional view a-a of the system for automatic trapping and counting of flying insects 1.

The main chamber 12 includes several intakes 10 through which insects can enter the main chamber 12.

Inside the main chamber 12 is a toxin chamber 20 which contains a toxin 21. The toxin 21 can contains a mixture of compounds that attract the insects under study and a toxin designed to kill or stun to insects which enter the main chamber 12.

An efficient mixture is a mixture of two compounds: ara-pheromone “trimedlure”, which is an attractant for male Medflies and Dichlorvos (four percent for example), a highly volatile organophosphate, widely used as an insecticide. The bait lures flying by males to enter the main chamber where they are killed within a few minutes by the insecticide.

The mixture of two compounds can be contained within the toxin chamber 20, when its components are separated from each other by a partition or any other suitable means, and they can even be contained within separate toxin chambers 20. This example is in no way limiting the present invention.

The results of killing the flies, stunning the flies, and a combination of both serve the present invention well.

The toxin chamber 21 includes a toxin chamber neck 22 which is covered by a mesh 23. The mesh 23 is used to keep insects from entering the toxin chamber 21.

This solution for prevention of entry of insects into the toxin chamber 21 as described is in no way limiting the present invention, and other solutions may be used, such as a narrow toxin chamber neck 22, which prevents passage of insects, thus rendering the use of mesh 23 unnecessary, or contrarily forgoing a toxin chamber neck 22 and using a lid with one or more small perforations instead of mesh 23, etc.

According to other embodiments, mesh 23 can be concave so that flies do not accumulate on it. Mesh 23 can also be mounted on the side of the toxin chamber neck 22, with the upper side of the toxin chamber neck 22 being concave. Mesh 23 can also be mounted on the side of the toxin chamber 20, which doesn't need to include the toxin chamber neck 22.

Insects are lured into the main chamber 12 by the fumes of the spread out through the intakes 10. Once the insects are inside the main chamber 12, they are killed or stunned by the toxin 12 and fall down to a funnel 30 places under the toxin chamber 20.

It is also possible not to kill the insects but only to stun them. From the funnel 30, the insects fall down a channel 31 and pass through a sensors assembly 40 into an insect collection chamber 50.

The sensors assembly 40 contains at least one optical sensor 41. Each time an insect falls through the sensor assembly 40, the optical sensor 41 detects it and signals the electronic sub-system 61 which updates the insect count.

The present illustration shows an electronic sub-system chamber 60 containing at least part of the electronic sub-system 61.

Note that even though the above description has made use of an optical sensor 41 or optical sensors 41, this is in no way limiting the present invention, and any other suitable sensor, such as a proximity sensor or an ultrasonic sensor, can be used alternatively.

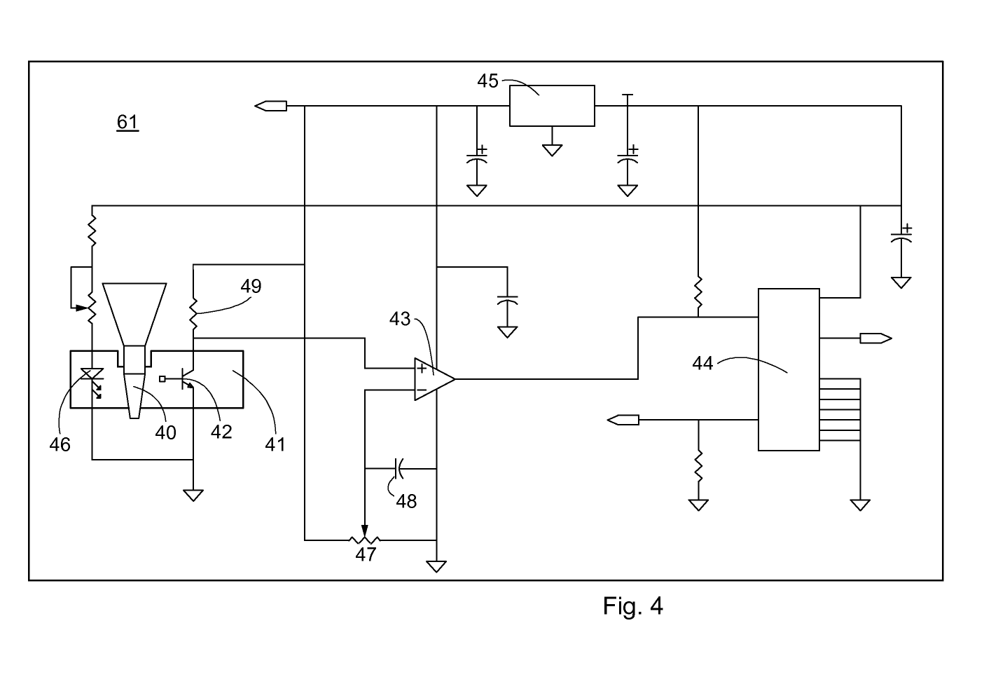

FIG. 4 is an electrical schematic of an exemplary embodiment of an electronic sub-system 61 of the system for automatic trapping and counting of flying insects 1, according to the present invention.

The main components of the electronic sub-system 61 are the optical sensor 41, an operational amplifier 43 and a counter 44.

The optical sensor 41 is composed of a light emitting diode (LED) 46 and a light sensitive transistor 42. The light coming from the LED 46 hits the light sensitive transistor 42, which turns on and outputs a voltage to the positive input of the operational amplifier 43. This voltage is set by a resistor 49. When a fly falls through the optical sensor 41, it blocks the light from the LED 46 and the light sensitive transistor 42, which turns off. When the light sensitive transistor 42 turns off the voltage that goes to the positive input of the operational amplifier 43 changes to the main power supply's voltage.

The negative input of the operational amplifier 43 is connected to a resistance adjustable resistor 47 and a capacitor 48 which together set the operational amplifier 41 voltage threshold upon which it changes its output. Thereby adjusting the sensitivity of the optical sensor 41.

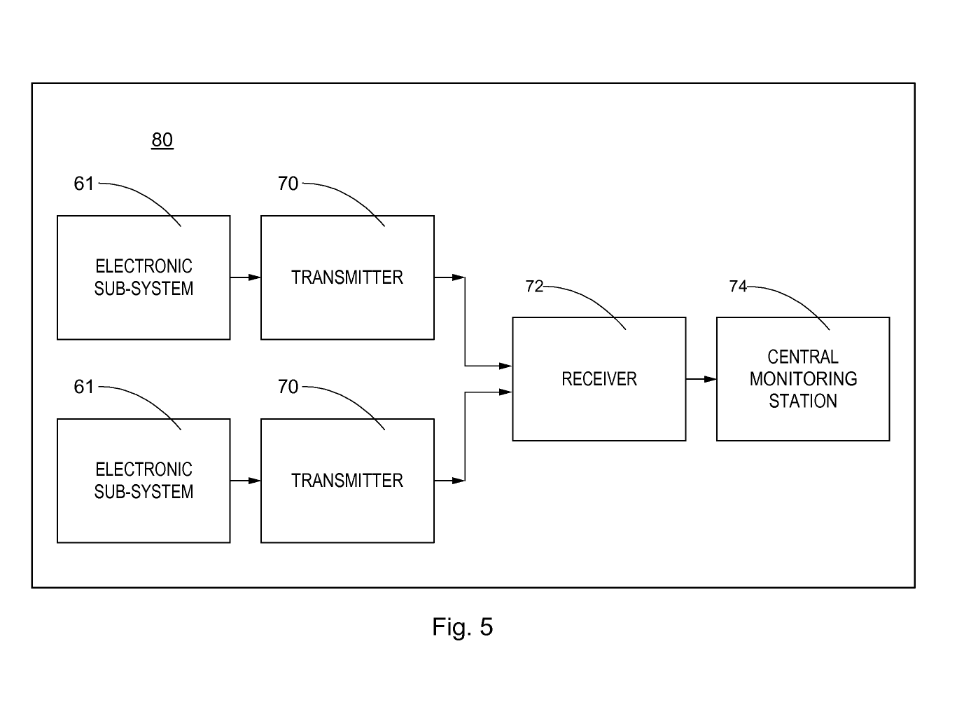

The operational amplifier 43 output is input to the counter 44 which counts the number of flies passing through the sensors assembly 40. The output of the counter 44 is connected to a transmitter 70 (not shown in the present illustration, shown in FIG. 5).

The electronic sub-system 61 also includes a voltage regulator 45. Certain components shown in the present illustration such as the optical sensor 41 and additional components of the sensors assembly as was already described, are not disposed within the electronic sub-system chamber 60 but rather within the main chamber 12 (both not shown in the present illustration, shown in FIGS. 1, 2, and 3).

FIG. 5 is a block diagram of an embodiment of the electrical portion 80 of the system for automatic trapping and counting of flying insects 1, according to the present invention.

The electrical portion 80 of the system for automatic trapping and counting of flying insects 1 includes an electronic sub-system 61, a transmitter 70, a receiver 72 and a central monitoring station 74.

The electronic sub-system 61 outputs the fly count to the transmitter 70 which transmits the count data using a wired or wireless communication protocol to the receiver 72. The count data is then input to the central monitoring station 74 which collects data from a number of systems for automatic trapping and counting of flying insects 1 spread around the monitored area. The count data of the various systems for automatic trapping and counting of flying insects 1 can then be analyzed by the central monitoring station 74.

In the present illustration, electronic sub-systems 61 output the fly count to the transmitters 70 of two systems for automatic trapping and counting of flying insects 1, however the present invention is not limited to this number.

Likewise, according to the present invention, there are other alternatives, such as transmitting the information to one central station or relaying it from one trap to the next (for example by means of ZigBee), according to the distances, and gathering the information in one place. Afterward, all the information with the identification of each trap can be transmitted to a cellular or other exchange. The transmitted information can also include:

trap number,

number of trappings,

time,

and climate conditions.

The main advantages of the system for automatic trapping and counting of flying insects 1 according to the present invention also include the stages of the method of its use, which include:
luring insects to enter into the main chamber;
stunning insects;
killing the insects; and
only after the killing and the stunning, if any, detecting and counting the insects.

Counting the insects is performed and reported with regard to periods of time as well as to other factors such as the temperature and humidity.

As part of the development of the present invention, experiments were conducted during which 4 systems for automatic trapping and counting of flying insects were placed near citrus trees in 4 occasions. The duration of each occasion ranged between 22 hours and 100 hours and 100-200 flies were released in the vicinity of the systems. In addition to the automatic systems, in the fourth experiment two Steiner traps were placed near the citrus trees for reference.

The following table describes the number of flies caught in each trap during the experiments:

| Experiment | | Automatic | Real | | % of flies from | % of flies from | Overll |
|---|---|---|---|---|---|---|---|
| # | Trap | Counts | Counts | Error | trapped flies | released flies | Accuracy |
| 1 | trap-4 | 7 | 7 | 0.0% | 17.9% | 7.0% | |
| 1 | trap-3 | 8 | 9 | −11.1% | 23.1% | 9.0% | |
| 1 | trap-2 | 16 | 17 | −5.9% | 43.6% | 17.0% | |
| 1 | trap-1 | 6 | 6 | 0.0% | 15.4% | 6.0% | |
| 1 | All traps | 37 | 39 | | | 39.0% | 94.9% |
| 2 | trap-4 | 6 | 3 | 100.0% | 12.0% | 3.0% | |
| 2 | trap-3 | 3 | 3 | 0.0% | 12.0% | 3.0% | |
| 2 | trap-2 | 15 | 15 | 0.0% | 60.0% | 15.0% | |
| 2 | trap-1 | 4 | 4 | 0.0% | 16.0% | 4.0% | |
| 2 | All traps | 28 | 25 | | | 25.0% | 100% |
| 3 | trap-4 | 25 | 23 | 8.7% | 29.1% | 25.0% | |
| 3 | trap-3 | 14 | 16 | −12.5% | 20.3% | 14.0% | |
| 3 | trap-2 | 17 | 16 | 6.3% | 20.3% | 17.0% | |
| 3 | trap-1 | 24 | 24 | 0.0% | 30.4% | 24.0% | |
| 3 | All traps | 80 | 79 | | | 80.0% | 97.5% |
| 4 | trap-4 | 38 | 37 | 2.7% | 14.5%* | 19.0% | |
| 4 | trap-3 | 40 | 40 | 0.0% | 15.6%* | 20.0% | |
| 4 | trap-2 | 61 | 63 | −3.2% | 24.6%* | 30.5% | |
| 4 | trap-1 | 35 | 32 | 9.4% | 12.5%* | 17.5% | |
| 4 | All auto traps | 174 | 172 | | | 87.0% | 98.8% |
| 4 | Steiner-1 | 41 | | | 16.0%* | 20.5% | |
| 4 | Steiner-2 | 43 | | | 16.4%* | 21.0% | |
| 4 | All 6 traps | | 255 | | | 128% | |

From the table above it is clear that the automatic system accuracy ranges between 95%-100%, and since there are 10 extra fly count (possibly due to native flies, other than the ones released during the experiment, due drops etc) out of the 315 released flies, the actual automatic system's accuracy is about 97% (10 out of 315=3%).

While the invention has been described with respect to a limited number of embodiments, it will be appreciated that many variations, modifications and other applications of the invention may be made.

What is claimed is:

1. A system for automatic trapping and counting of flying insects (1), the system comprising:
(a) a main chamber (12) having at least one intake (10);
(b) a toxin chamber (20) having a toxin chamber neck (22), said toxin chamber (20) being located at least partly inside said main chamber (12);
(c) a funnel (30) located inside said main chamber (12);
(d) a channel (31) attached to said funnel (30);
(e) a sensors assembly (40) attached to said channel (31); and
(g) an insect collecting chamber (50), located inside said main chamber (12).

2. The system for automatic trapping and counting of flying insects (1) of claim 1, wherein said toxin chamber (20) is configured to contain toxin (21).

3. The system for automatic trapping and counting of flying insects (1) of claim 2, wherein said toxin (21) contains a mixture of compounds for attracting and killing insects.

4. The system for automatic trapping and counting of flying insects (1) of claim 2 wherein said toxin (21) contains a mixture of para-pheromone and Dichlorvos.

5. The system for automatic trapping and counting of flying insects (1) of claim 1, wherein said toxin chamber neck (22) is covered by a mesh (23), wherein said mesh (23) is configured for keeping certain insects from entering said toxin chamber (21).

6. The system for automatic trapping and counting of flying insects (1) of claim 1, wherein said toxin chamber (20) is configured to be located, at operation, higher than said sensors assembly (40).

7. The system for automatic trapping and counting of flying insects (1) of claim 1, wherein said toxin chamber (20) is configured to be located, at operation, higher than said insect collecting chamber (50).

8. The system for automatic trapping and counting of flying insects (1) of claim 3 further comprising:
(h) an electronic sub-system chamber (60) mechanically connected to said main chamber (12).

9. The system for automatic trapping and counting of flying insects (1) of claim 1 further comprising:
(h) an electronic sub-system chamber (60), wherein said electronic sub-system chamber (60) contains at least part of an electronic sub-system (61).

10. The system for automatic trapping and counting of flying insects (1) of claim 9, wherein said sensors assembly (40) includes at least one optical sensor (41).

11. The system for automatic trapping and counting of flying insects (1) of claim 10, wherein said electronic sub-system (61) includes:
(i) an operational amplifier (43) operatively connected to said at least one optical sensor (41); and
(ii) a counter (44) operatively connected to said operational amplifier (43).

12. The system for automatic trapping and counting of flying insects (1) of claim 9, wherein said electronic sub-system (61) is configured to transmit counted data to a receiver (72) wherein said count data serves as input to a central monitoring station (74).

13. The system for automatic trapping and counting of flying insects (1) of claim 12, wherein said central monitoring station (74) is configured also for collecting data from another systems for automatic trapping and counting of flying insects (1).
